(19) United States
(12) Patent Application Publication
(10) Pub. No.: US 2026/0117574 A1
(43) Pub. Date: Apr. 30, 2026

(54) ROLLER CARRIAGES

(71) Applicant: Anthony Innovations Pty Ltd., Epping (AU)

(72) Inventor: Ryan William Martin, Epping (AU)

(73) Assignee: Anthony Innovations Pty Ltd., Epping, VI (AU)

(21) Appl. No.: 19/369,402

(22) Filed: Oct. 27, 2025

(30) Foreign Application Priority Data
Oct. 30, 2024 (US) 2024903532

(51) Int. Cl. E05D 15/06

(52) U.S. Cl. CPC E05D 15/0665; E05Y 2900/132; E05Y 2900/148

(57) ABSTRACT

A roller carriage for a sliding panel with an outer housing enclosing an internal space, a main roller assembly for carrying a main roller wheel disposed within one end of the internal space and configured to be movable relative to the outer housing, and an auxiliary roller assembly for carrying an auxiliary roller wheel disposed within the internal space adjacent to the main roller assembly and being configured to be movable relative to the outer housing. The main roller assembly is coupled to the auxiliary roller assembly so that the main roller wheel and the auxiliary roller wheel are connectedly movable relative to the outer housing such that when a force is applied to the main roller wheel and the auxiliary roller wheel by the weight of the sliding panel the force is balanced evenly over the roller wheels carried by the main roller assembly and the auxiliary roller assembly.

### FIELD OF THE INVENTION

The present invention generally relates to roller carriages having roller wheel assemblies, and in particular, to roller carriages of the type intended to support sliding panels such as doors and windows.

### BACKGROUND TO THE INVENTION

Conventional roller assemblies for sliding panels have roller wheels within carriages that are located within a cavity of the panel. These assemblies will typically have two roller wheel carriages, with one located towards the lower front corner and one towards the lower rear corner of the sliding panel.

Other roller assemblies exist for low or slim line sliding panel systems which have rollers mounted in the sill of the door or window frame. One purpose of these systems is to reduce the outer frame size of the panel, for example to enable larger glass sections to maximize outdoor views and natural light.

A problem with existing sliding door and window rollers is that for even load distribution between rollers within the panel, the load is usually applied between only two equidistant positions. In a system with only two wheels, these points are usually the axles. When loads increase, additional wheels are required to support the increased load, which then requires additional mechanisms to ensure the load is still applied through the two equidistant positions. These additional mechanisms increase in complexity as door loads increase and quantity of wheels required increases. Increasing the complexity of the mechanism increases costs.

In sliding panels with multiple wheels not all the wheels will be evenly in contact with the rolling surface to the same degree, such that one or more of the wheels may receive a greater force from the panel than others. This problem can arise because the sill is often not perfectly level, for example through curvature in the sill or door/window frame. This problem can also be caused by the panel itself not having a perfectly straight edge, such as where the panel is assembled on an uneven surface. As a result, the weight of a panel may not be evenly distributed between the roller wheels. This can lead to performance issues, such as a sliding motion of the panel not being smooth or the panel being difficult to move. In some cases, this problem can lead to too high a percentage of the weight of the panel being received by a single wheel, which can lead to failure or buckling of the wheel such that the sliding panel will not function.

The applicant has observed that one of the issues with uneven weight distribution of the slidable panel between the wheels is that bowing of the wall of the housing of the roller assembly can occur. This has been observed in roller assemblies with multiple wheels where if the weight is not evenly distributed the weight is concentrated on the one or more of the few connection points of the mechanisms holding the wheels to the housing of the roller assemblies, for example where the axles meet the housing walls. It is not desirable to increase the thickness of the walls of the housing as there is limited space in the recess of the sill.

It is desirable for embodiments of the present invention to address at least partially one or more of the disadvantages of the methods or systems above. Further it is preferred that embodiments of the present invention provide a system and method which has improved performance in providing superior evenness of weight distribution for sliding door panels, particularly for heavier doors and windows and/or less ideal conditions such as uneven sills or panel edges. It is also preferred that embodiments of the present invention also produce a system which can accommodate a wide range of sliding doors and windows having different weights, and which can allow even weight distribution in variety of conditions.

It is to be understood that, if any prior art publication is referred to herein, such reference does not constitute an admission that the publication forms a part of the common general knowledge in the art, in Australia or any other country.

### SUMMARY OF THE INVENTION

According to a first aspect of the present invention, there is provided a roller carriage for a sliding panel comprising: an outer housing enclosing an internal space; a main roller assembly for carrying a main roller wheel, the main roller assembly being disposed within one end of the internal space and being configured to be movable relative to the outer housing; an auxiliary roller assembly for carrying an auxiliary roller wheel disposed within the internal space adjacent to the main roller assembly and being configured to be movable relative to the outer housing; wherein the main roller assembly is coupled to the auxiliary roller assembly so that the main roller wheel and the auxiliary roller wheel of the auxiliary roller assembly are connectedly movable relative to the outer housing such that when a force is applied to the main roller wheel and the auxiliary roller wheel by the weight of the sliding panel the force is balanced evenly over the roller wheels carried by the main roller assembly and the auxiliary roller assembly. In this way, as the main roller assembly and auxiliary roller assembly are coupled in the roller carriage the force exerted by the sliding panel is able to balance evenly between the main and auxiliary roller assemblies for improved balance and weight distribution of the sliding panel on the roller carriage.

In an embodiment, the main roller assembly further comprises: a first end and a second end: a main retaining means disposed at the first end for movably retaining the main roller assembly within the outer housing; and the auxiliary roller assembly further comprises: a first end and a second end: an auxiliary retaining means disposed at the first end of the auxiliary roller assembly for retaining the auxiliary roller assembly within the outer housing; wherein the second end of the main retaining means is configured to the auxiliary retaining means at the first end of the auxiliary retaining means to couple the main roller assembly to the auxiliary roller assembly. By having multiple retaining means, this avoids the weight of the panel being concentrated on a single retaining means as occurs in the prior, and prevents bowing or unwanted deflection of the components, such as axle elements or outer housing.

In an embodiment, the main retaining means is configured to allow the main roller assembly to be pivotally retained in the outer housing, and wherein the auxiliary retaining means is configured to allow the auxiliary roller assembly and main auxiliary roller assembly to be pivotally retained in the outer housing.

In an embodiment, the main retaining means is configured to allow the main roller assembly to be slidably retained in the outer housing, and wherein the auxiliary retaining means is configured to allow the auxiliary roller assembly and main roller assembly to be slidably retained in the outer housing

In an embodiment, the coupling of the main and auxiliary roller assemblies is a slidable and pivotable coupling.

In an embodiment, the main roller assembly is configured to resiliently carry the main roller wheel and/or the auxiliary roller assembly is configured to resiliently carry the auxiliary roller wheel.

In a preferred embodiment, the main roller assembly further comprises: a main inner housing; a main wheel carrying member for carrying the main roller wheel, and a main resilient member and wherein the main resilient member extends between the main inner housing and the main wheel carrying member for allowing resilient movement of the main roller wheel inwardly relative to the main inner housing when the force is applied to the main wheel.

Preferably, at the first end of the main roller assembly the main inner housing is pivotally connected to the main wheel carrying member by the main retaining means, and wherein at the second end of the main roller assembly the main resilient member extends between the main inner housing and the main wheel carrying member to allow pivotal resilient movement of the main roller wheel. Thus, the arrangement of the main inner housing, main resilient member and main wheel carrying member forms an independent suspension means for the main roller wheel.

In a preferred embodiment, the auxiliary roller assembly further comprises: an auxiliary inner member an auxiliary wheel carrying member for carrying the auxiliary roller wheel, and an auxiliary resilient member and wherein the auxiliary resilient member extends between the auxiliary inner housing and the auxiliary wheel carrying member for allowing resilient movement of the auxiliary roller wheel inwardly relative to the auxiliary inner housing when the force is applied to the auxiliary roller wheel. Thus, the arrangement of the auxiliary inner housing, auxiliary resilient member and auxiliary wheel carrying member forms an independent suspension means for the auxiliary roller wheel, separate to the suspension means for the main roller wheel.

In an embodiment, the main retaining means comprises: a main axle element for connecting the main inner housing to apertures in the outer housing, the main axle element configured to extend between side walls of the main inner housing and outer housing and wherein the main axle element allows the main roller assembly to pivot about the main axle element, and the auxiliary retaining means comprises an auxiliary axle element for connecting the auxiliary inner housing to apertures in the outer housing, the auxiliary axle element extending between the side walls of the auxiliary inner housing and outer housing and wherein the main axle element allows the auxiliary roller assembly to pivot about the main axle element. The rotational movement by way of the axle elements and the apertures has the effect of allow the inner housings to move in substantially parallel translation to the outer housing.

In an embodiment, the apertures in the outer housing are elongated slots which allow the main roller assembly and/or the auxiliary assembly to be slidable relative to the outer housing. The angled slots allow both vertical and horizontal movement of the roller assemblies relative to the outer housing.

In an embodiment, the main resilient member and/or the auxiliary resilient member comprises one or more springs.

In an embodiment, the auxiliary roller assembly is one of two or more auxiliary roller assemblies coupled in succession wherein each auxiliary roller assembly is movably coupled to a succeeding auxiliary roller assembly in the internal space and each of the auxiliary roller assemblies is further configured to be movably retained in the outer housing for balancing the force over the main roller assembly and the auxiliary roller assemblies.

Preferably, each of the auxiliary roller assemblies further comprises: a first end and a second end: an auxiliary retaining means disposed at the first end of the auxiliary roller assembly for retaining the auxiliary roller assembly within the outer housing; wherein each of the auxiliary roller assemblies is pivotally and slidably connected to the auxiliary retaining means of the succeeding auxiliary roller assembly.

In an embodiment, each of the two or more auxiliary roller assemblies is configured to resiliently carry an auxiliary roller wheel for allowing resilient movement of the auxiliary roller wheel inwardly relative to the auxiliary inner housing when the force is applied to the auxiliary roller wheel.

In an embodiment, the roller carriage further comprises an adjustment assembly disposed at the end of the internal space, the adjustment assembly being connected to the main roller assembly for adjusting the lateral position of the main roller assembly and any auxiliary roller assemblies connected to the main relative to the outer housing. By adjustment of the adjustment assembly allows vertical movement of the roller assemblies relative to the outer housing subsequently allows height adjustment of the roller carriage and the sliding panel which rests on the roller carriage

Preferably, the outer housing is configured to be mounted in a recess of a sill for a slidable panel.

In an embodiment, the main roller assembly and one or more auxiliary roller assemblies allow rotatable movement of the main and auxiliary roller wheels to allow the slidable panel to move within the recess of the sill.

According to another aspect of the present invention, there is provided a system for use for supporting a slidable panel comprising a plurality of roller carriages of any one of the preceding claims, wherein the each of the roller carriages are mounted spaced apart within a recess of a sill, and wherein the roller carriages are configured such that when the slidable panel is placed on the roller carriages thereby applying a force on the roller carriages that the force is balanced evenly over the roller carriages, and the coupled main and auxiliary roller assemblies of each roller carriage. In this way, as the main roller assembly and auxiliary roller assembly are coupled in the roller carriage the force exerted by the sliding panel is able to balance evenly between the main and auxiliary roller assemblies for improved balance and weight distribution of the sliding panel on the roller carriage.

### BRIEF DESCRIPTION OF THE DRAWINGS

One or more embodiments of the present invention will hereinafter be described with reference to the accompanying Figures, in which:

FIG. 1 is a bottom perspective view of a roller carriage having a main roller assembly coupled to an auxiliary roller assembly according to a preferred embodiment of the present invention;

FIG. 2 is a bottom perspective view of another roller carriage having a main roller assembly coupled to two auxiliary roller assemblies according to another preferred embodiment of the present invention;

FIG. 3 is a side view of the roller carriage of FIG. 2 showing one of the auxiliary roller assemblies in an exploded form for illustrative purposes;

FIG. 4 is a side view of the roller carriage of FIG. 2 and showing a main roller assembly and the auxiliary roller assemblies in an exploded form for illustrative purposes;

FIG. 5 is a top view of the roller carriage of FIG. 2;

FIG. 6 is a cross-section view of the roller carriage of FIG. 2 through the dotted line of A-A of FIG. 4 showing the inner housings of the main and auxiliary roller assemblies;

FIG. 7 is a cross-section view of the roller carriage of FIG. 2 through the dotted line of B-B of FIG. 4 showing the wheel carrying members of the main and auxiliary roller assemblies; and

FIG. 8 is a cross-section view of the roller carriage of FIG. 2 through the dotted line of C-C of FIG. 4 showing the roller wheels, wheel carrying members and resilient members of the main and auxiliary roller assemblies.

### DETAILED DESCRIPTION OF THE DRAWINGS

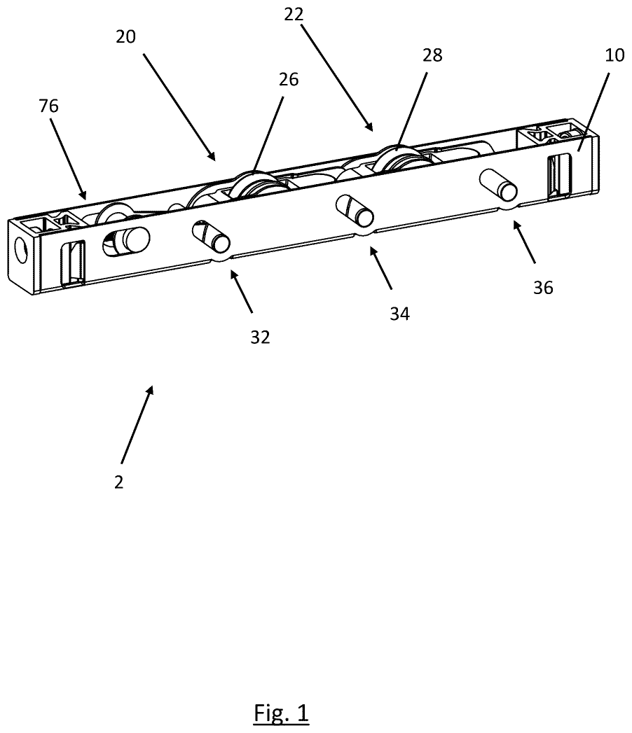

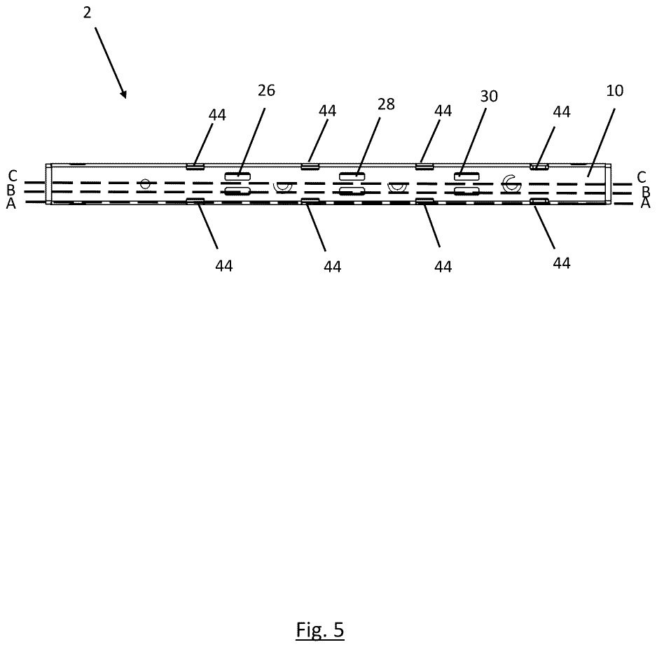

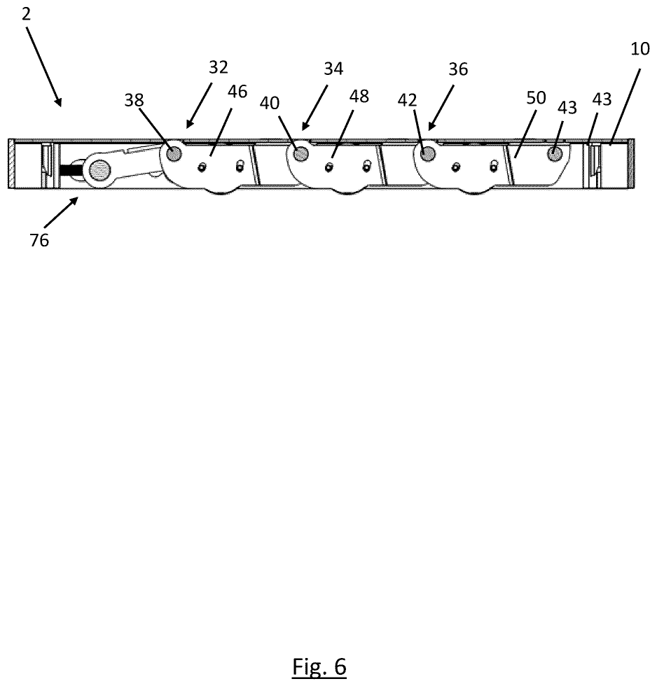

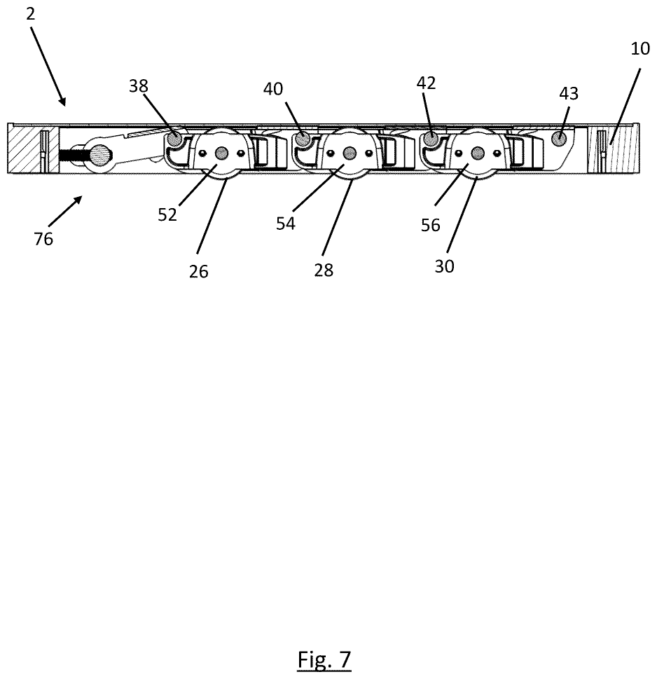

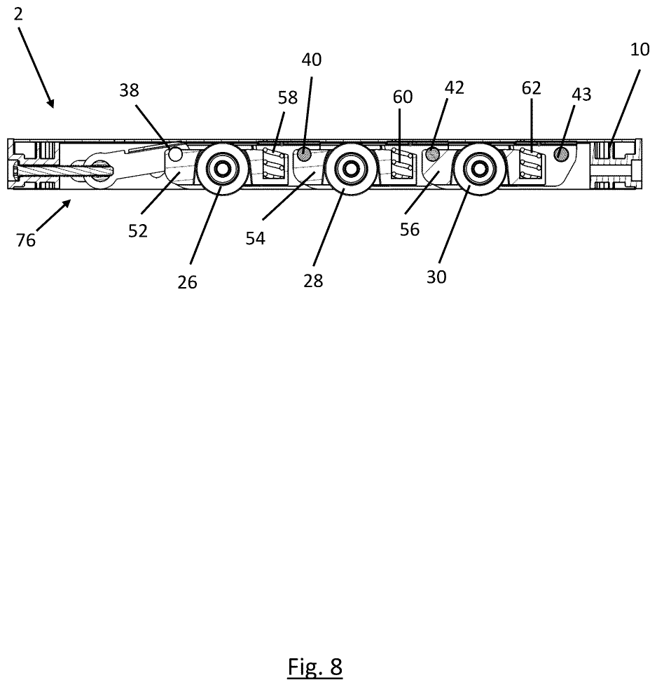

Referring now to FIGS. 1 to 8, there is described a roller carriage 2 for a sliding panel according to a preferred embodiment of the present invention. The roller carriage 2 has an outer housing 10 which is able to define an internal space in which at least two roller assemblies 20, 22, 24 are housed. The roller carriage 2 can comprise a first or main roller assembly 20 which is disposed at an end of the enclosed space, and one or more auxiliary roller assemblies 22, 24 which are coupled to the main roller assembly 20.

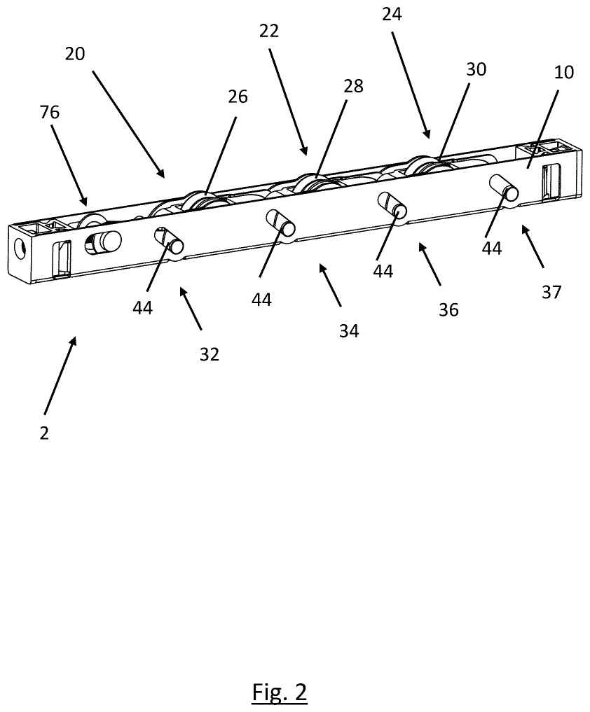

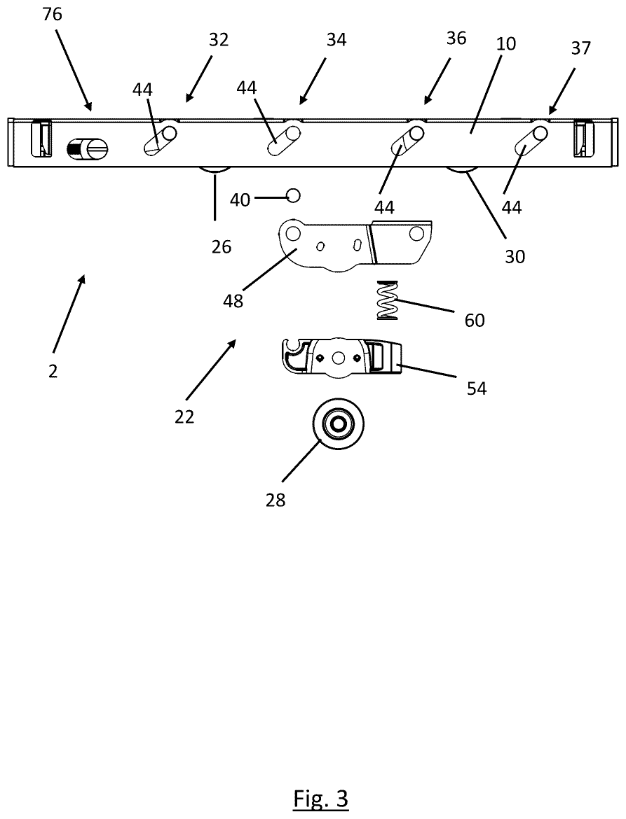

Each of the roller assemblies 20, 22, 24 are configured to carry a roller wheel 26, 28, 30. The roller wheels 26, 28, 30 are rotatably mounted in the roller assemblies 20, 22, 24. In use, as illustrated in FIGS. 3 to 8 the roller wheels 26, 28, 30 protrude below a lower edge of the outer housing 10 so as to allow the sliding panel resting on the roller carriage 2 to be supported by the roller wheels 26, 28, 30 and allow the sliding panel to be movable within a recess of a sill. In FIGS. 1 and 2, the roller carriage 2 is shown as a bottom view so that the roller wheels 26, 28, 30 protrude upwardly purely for illustrative purposes.

As illustrated in the example in FIGS. 1 to 8, the main roller assembly 20 carries a main roller wheel 26, while each of the auxiliary roller assemblies 22, 24 carries an auxiliary roller wheel 28, 30. While in the examples shown in FIGS. 2 to 8 show two auxiliary roller assemblies 22 and 24, the applicant also expects that the roller carriage 2 would also function with one main roller assembly 20 and one auxiliary roller assembly 22 as a minimum as exemplified in FIG. 1. In addition, it is expected that the roller carriage 2 could also include three or more auxiliary roller assemblies, where the three or more roller assemblies are connected together and coupled to one side of the main roller assembly 20.

The main roller assembly 20 has a main retaining means 32 for movably retaining the main roller assembly 20 to the outer housing 10 and the auxiliary roller assembly 22 has an auxiliary retaining means 34 for movably retaining the auxiliary roller assembly 22 to the outer housing 10. The retaining means 32, 34 are configured to allow the slidable or swinging movement of the roller assemblies 20, 22 relative to the outer housing 10 and preferably configured to allow both slidable and swinging movement. There is also a further auxiliary retaining means 36, 37 which connects the distal end of the auxiliary roller assembly 22 in FIG. 1 and auxiliary roller assembly 24 in FIGS. 2 to 8 so that each roller assembly 20, 22 and 24 are both retained by a pair of retaining means at opposite ends of each roller assembly 20, 22 and 24. Thus preferably the two or three or more successively coupled roller assemblies 20, 22, 24 form a train of roller assemblies where each roller assembly is coupled to another adjacent roller assembly 20, 22, 24 as well as to the outer housing 10 by retaining means 34,36 (,37). In a preferred embodiment having retaining means which provide swinging movement at either end of the train of roller assemblies and having retaining means coupling adjoining roller assemblies, the roller assemblies 20, 22, 24 can move in substantially parallel translation to the outer housing 10.

By coupling one auxiliary roller assembly 22 to the main roller assembly 20 and allowing slidable and pivotal movement of each roller assembly 20, 22, 24 to the outer housing 10 allows a force exerted on the roller carriage 2 by the weight of the sliding panel to be balanced evenly over the two or more roller assemblies 20, 22, 24. Similarly, as illustrated in the FIGS. 1 to 8, when the two auxiliary roller assemblies 22, 24 are coupled to the main roller assembly 20, then the force exerted by the sliding panel is able to balance evenly between the three roller assemblies 20, 22 and 24 for improved balance and weight distribution of the sliding panel on the roller carriage 2.

As illustrated in the FIGS. 1 to 8, the retaining means 32, 34, 36 can be in the form of axle elements 38, 40, 42 which extends between apertures 44 in the outer housing 10 which can allow free rotational movement of the axle elements 38, 40, 42 within the apertures 44. Preferably, as illustrated the apertures 44 can be slots which allow slidable movement of the roller assemblies 20, 22, 24 relative to the outer housing 10. More preferably, the apertures 44 are angled slots which allows both vertical and horizontal movement of the roller assemblies 20, 22, 24 relative to the outer housing 10. This movement of the roller assemblies 20, 22, 24 relative to the outer housing 10 subsequently allows height adjustment of the roller carriage 2 and the sliding panel which rests on the roller carriage 2 by way of an adjustment assembly 76 which is discussed in more detail below.

By having multiple roller wheels, each being mounted in its own roller assemblies 20, 22, 24 at multiple retaining means 32, 34, 36 and 37 where the weight is distributed evenly, not only over the roller wheels 26, 28, 30 but also over the retaining means 32, 34, 36 and 37. This avoids the weight of the panel being concentrated on or more retaining means 32, 34, 36 and 37, and prevents bowing or unwanted deflection of the components, such as axle elements or outer housing.

To couple the main roller assembly 20 to the first auxiliary roller assembly 22, the second end of the main roller assembly 20 is configured to pivotally connect to the auxiliary retaining means 34 at a first end of the auxiliary roller assembly 22.

Any additional auxiliary roller assemblies 24 are then connected similarly in succession to the first auxiliary roller assembly 22. As illustrated in the examples of FIGS. 1 to 8, each of the first ends of the auxiliary roller assemblies 22, 24 are retained by the auxiliary retaining means 34, 36 and the second end of auxiliary roller assemblies 22 is coupled to a succeeding roller assembly 24.

Each of the roller assemblies 20, 22, 24 is also configured to allow mounting of a respective roller wheel 26, 28, 30 in a way that allows resilient movement of the roller wheels 26, 28, 30 relative to the inner housing 46, 48, 50. This enables each roller assembly 20, 22, 24 to function as individual suspension members within the roller carriage 2, each of the suspension members capable of independent resilient movement relative to each other. This advantageously allows each roller assembly 20, 22, 24 to adjust positions independently so that the lower edge of the sliding panel is as level as possible.

As illustrated in FIGS. 1 to 8, to enable the resilient movement, each roller assembly 20, 22, 24 comprises an inner housing 46, 48, 50 and a wheel carrying member 52, 53, 56 for rotatably mounting a respective roller wheel 26, 28, 30. In each roller assembly 20, 22, 24 the inner housing 46, 48, 50 and the wheel carrying member 52, 53, 56 is connected pivotally at first ends to a respective retaining means 32, 34, 36, 37 while at the opposite ends or second ends, a resilient member 58, 60, 62 extends between the inner housing 46, 48, 50 and the wheel carrying member 52, 53, 56.

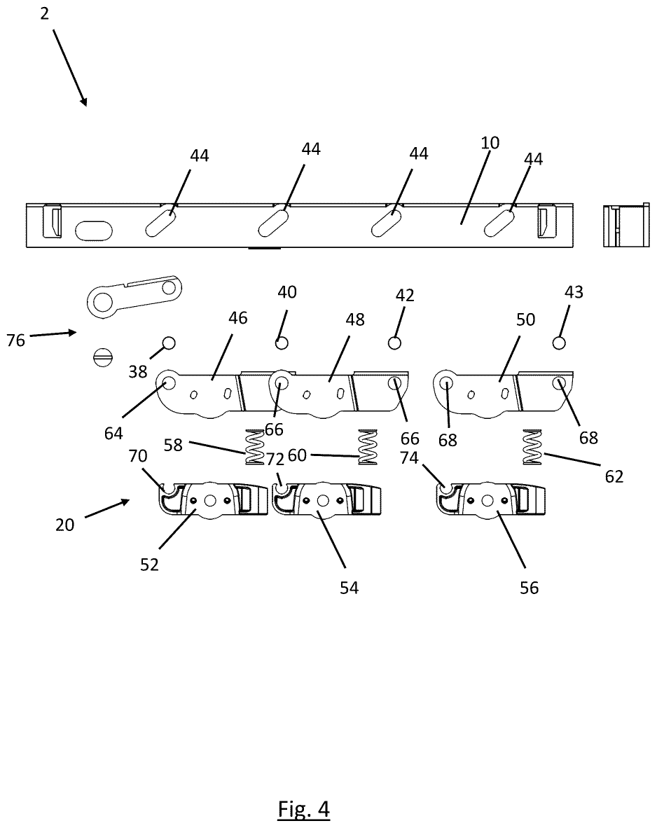

As shown particularly in FIG. 4, a main resilient member 58 in the form of a spring extends between the second ends of the main inner housing 46 and wheel carrying member 52 to allow resilient pivotal movement of the roller wheel 26 about the main axle element 38 at which the first ends of the main inner housing 46 and wheel carrying member 52 are pivotally connected. The auxiliary roller assemblies have resilient members 60, 62 in the form of springs which are similarly arranged between the auxiliary inner housing 48, 50 and auxiliary wheel carrying member 54, 56 to allow pivotal resilient movement of the respective roller wheel 28, 30 about the auxiliary axle elements 40, 42. The second ends of the inner housing 46, 48, 50 has an upper wall which extends between the side walls of the inner housing 46, 48, 50, and similarly the second ends of the wheel carrying members 52, 54 56 have a lower wall which extends between the side walls of the wheel carrying members 52, 54, 56, where the upper wall and lower wall form upper and lower seats for holding the ends of the springs 58, 60, 62 securely.

As particularly illustrated in FIG. 4, the main inner housing 46 and auxiliary inner housing 48, 50 are sized to fit within the internal space and have retaining means 32, 35, 36, 37 in the form of apertures 64, 66, 68 provided at opposing side walls of the inner housing 46, 48, 50 through which axle elements 38, 40, 42 are rotatably received. Each of the inner housings 46, 48, 50 is therefore connected at opposite ends by retaining means 32, 34, 36, 37, which allow rotational movement by way of the axle elements 38, 40, 42 and the apertures 64, 66, 68, which has the effect of allow the inner housings 46, 48, 50 (and the roller assemblies 20, 22 and 24) to move in substantially parallel translation to the outer housing 10. Similarly, the wheel carrying members 52, 54, 56 are sized to fit within the respective inner housings 46, 48, 50, and have recesses 70, 72, 74 which are sized to receive the axle elements 38, 40, 42 and allow pivoting movement about those axle elements 38, 40, 42.

The recesses 70, 72, 74 also have the benefit of allowing the wheel carrying members 52, 54, 56 to be easily detached, replaced or reattached for maintenance or replacement purposes. Alternatively, the recesses 70, 72, 74 could also be apertures, similar to those used in the inner and outer housing 10, 46, 48, 50. Similarly, the wheel carrying members 52, 54, 56 can be configured to allow the roller wheels 26, 28, 30 to be detached or replaced.

As illustrated in FIGS. 4 and 6 to 8, the roller carriage 2 also comprises an adjustment assembly 76 disposed at the end of the internal space intermediate the end of the roller carriage 2 and the main roller assembly 20. The adjustment assembly 76 is connected to the main roller assembly 20 to allow adjustment of the lateral or vertical position of the main roller assembly 20 and any auxiliary roller assemblies 22, 24 connected to the main roller assembly 20 relative to the outer housing 10 by way of the angled slots 44. The adjustment of the lateral position can be made by a user manually manipulating a screw type mechanism external to the outer housing 10. By manipulation of the adjustment assembly 76, the user can adjust height of the roller assemblies 20, 22, 24 relative to the outer housing 10. This further allows height adjustment of the roller carriage 2 and the sliding panel which rests on the roller carriage 2. The adjustment assembly 76 can also be used to level the sliding panel if the sill is not level.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

Reference numeral table

| | |
|---|---|
| 2 | Roller carriage |
| 10 | Outer Housing |
| 20 | Main roller assembly |
| 22 | Auxiliary roller assembly |
| 24 | Auxiliary roller assembly |
| 26 | Main roller wheel |
| 28 | Auxiliary roller wheel |
| 30 | Auxiliary roller wheel |
| 32 | Main retaining means |
| 34, 36, 37 | Auxiliary retaining means |
| 38 | Main axle element |
| 40, 42, 43 | Auxiliary axle element |
| 44 | Apertures |
| 46 | Main inner housing |
| 48, 50 | Auxiliary inner housing |
| 52 | Main Wheel carrying member |
| 54, 56 | Auxiliary wheel carrying member |
| 58 | Main resilient member |
| 60, 62 | Auxiliary resilient member |
| 64 | Main inner housing apertures |
| 66, 68 | Auxiliary inner housing aperture |
| 70 | Main recess |
| 72, 74 | Auxiliary recess |
| 76 | Adjustment assembly |

1. A roller carriage for a sliding panel comprising:
an outer housing enclosing an internal space;
a main roller assembly for carrying a main roller wheel, the main roller assembly being disposed within one end of the internal space and being configured to be movable relative to the outer housing;
an auxiliary roller assembly for carrying an auxiliary roller wheel disposed within the internal space adjacent to the main roller assembly and being configured to be movable relative to the outer housing; and
wherein the main roller assembly is coupled to the auxiliary roller assembly so that the main roller wheel and the auxiliary roller wheel of the auxiliary roller assembly are connectedly movable relative to the outer housing such that when a force is applied to the main roller wheel and the auxiliary roller wheel by the weight of the sliding panel the force is balanced evenly over the roller wheels carried by the main roller assembly and the auxiliary roller assembly.

2. The roller carriage of claim 1, wherein the main roller assembly further comprises:
a first end and a second end:
a main retaining means disposed at the first end for movably retaining the main roller assembly within the outer housing; and
the auxiliary roller assembly further comprises:
a first end and a second end; and
an auxiliary retaining means disposed at the first end of the auxiliary roller assembly for retaining the auxiliary roller assembly within the outer housing;
wherein the second end of the main retaining means is configured to the auxiliary retaining means at the first end of the auxiliary retaining means to couple the main roller assembly to the auxiliary roller assembly.

3. The roller carriage of claim 2, wherein the main retaining means is configured to allow the main roller assembly to be pivotally retained in the outer housing, and wherein the auxiliary retaining means is configured to allow the auxiliary roller assembly and main auxiliary roller assembly to be pivotally retained in the outer housing.

4. The roller carriage of claim 2, wherein the main retaining means is configured to allow the main roller assembly to be slidably retained in the outer housing, and wherein the auxiliary retaining means is configured to allow the auxiliary roller assembly and main roller assembly to be slidably retained in the outer housing.

5. The roller carriage of claim 1, wherein the coupling of the main and auxiliary roller assemblies is a slidable and pivotable coupling.

6. The roller carriage of claim 1, wherein the main roller assembly is configured to resiliently carry the main roller wheel and/or the auxiliary roller assembly is configured to resiliently carry the auxiliary roller wheel.

7. The roller carriage of claim 6, wherein the main roller assembly further comprises:
a main inner housing;
a main wheel carrying member for carrying the main roller wheel;
a main resilient member; and
wherein the main resilient member extends between the main inner housing and the main wheel carrying member for allowing resilient movement of the main roller wheel inwardly relative to the main inner housing when the force is applied to the main wheel.

8. The roller carriage of claim 6, wherein at the first end of the main roller assembly the main inner housing is pivotally connected to the main wheel carrying member by the main retaining means, and wherein at the second end of the main roller assembly the main resilient member extends between the main inner housing and the main wheel carrying member to allow pivotal resilient movement of the main roller wheel.

9. The roller carriage of claim 6, wherein the auxiliary roller assembly further comprises:
an auxiliary inner member;
an auxiliary wheel carrying member for carrying the auxiliary roller wheel;
an auxiliary resilient member; and
wherein the auxiliary resilient member extends between the auxiliary inner housing and the auxiliary wheel carrying member for allowing resilient movement of the auxiliary roller wheel inwardly relative to the auxiliary inner housing when the force is applied to the auxiliary roller wheel.

10. The roller carriage of claim 2, wherein the main retaining means comprises:
a main axle element for connecting the main inner housing to apertures in the outer housing, the main axle element configured to extend between side walls of the main inner housing and outer housing and wherein the main axle element allows the main roller assembly to pivot about the main axle element; and
the auxiliary retaining means comprises an auxiliary axle element for connecting the auxiliary inner housing to apertures in the outer housing, the auxiliary axle element extending between the side walls of the auxiliary inner housing and outer housing and wherein the main axle element allows the auxiliary roller assembly to pivot about the main axle element.

11. The roller carriage of claim 8, wherein the apertures in the outer housing are elongated slots which allow the main roller assembly and/or the auxiliary assembly to be slidable relative to the outer housing.

12. The roller carriage of claim 7, wherein the main resilient member and/or the auxiliary resilient member comprises one or more springs.

13. The roller carriage of claim 1, wherein the auxiliary roller assembly is one of two or more auxiliary roller assemblies coupled in succession wherein each auxiliary roller assembly is movably coupled to a succeeding auxiliary roller assembly in the internal space and each of the auxiliary roller assemblies is further configured to be movably retained in the outer housing for balancing the force over the main roller assembly and the auxiliary roller assemblies.

14. The roller assembly of claim 13, wherein each of the auxiliary roller assemblies further comprises:
a first end and a second end:
an auxiliary retaining means disposed at the first end of the auxiliary roller assembly for retaining the auxiliary roller assembly within the outer housing;
wherein each of the auxiliary roller assemblies is pivotally and slidably connected to the auxiliary retaining means of the succeeding auxiliary roller assembly.

15. The roller carriage of claim 14 wherein each of the two or more auxiliary roller assemblies is configured to resiliently carry an auxiliary roller wheel for allowing resilient movement of the auxiliary roller wheel inwardly relative to the auxiliary inner housing when the force is applied to the auxiliary roller wheel.

16. The roller carriage of claim 1, wherein the roller carriage further comprises an adjustment assembly disposed at the end of the internal space, the adjustment assembly being connected to the main roller assembly for adjusting the lateral position of the main roller assembly and any auxiliary roller assemblies connected to the main relative to the outer housing.

17. The roller carriage of claim 1 wherein the outer housing is configured to be mounted in a recess of a sill for a slidable panel.

18. The roller carriage of claim 17, wherein the main roller assembly and one or more auxiliary roller assemblies allow rotatable movement of the main and auxiliary roller wheels to allow the slidable panel to move within the recess of the sill.

19. A system for use for supporting a slidable panel comprising a plurality of roller carriages, each roller carriage being the roller carriage of claim 1, wherein the each of the roller carriages are mounted spaced apart within a recess of a sill, and wherein the roller carriages are configured such that when the slidable panel is placed on the roller carriages thereby applying a force on the roller carriages that the force is balanced evenly over the roller carriages, and the coupled main and auxiliary roller assemblies of each roller carriage.
